(19) United States
(12) Patent Application Publication
(10) Pub. No.: US 2013/0167156 A1
(43) Pub. Date: Jun. 27, 2013

(54) WEB PAGE TO TOOLBAR COMMUNICATION

(71) Applicants: Bryan Ressler, Sammamish, WA (US); Georgi Nikolov, Mountain View, CA (US); Sami Khoury, Kirkland, WA (US); Parrish Munsell, Woodinville, WA (US)

(72) Inventors: Bryan Ressler, Sammamish, WA (US); Georgi Nikolov, Mountain View, CA (US); Sami Khoury, Kirkland, WA (US); Parrish Munsell, Woodinville, WA (US)

(73) Assignee: MICROSOFT CORPORATION, Redmond, WA (US)

(21) Appl. No.: 13/334,043

(22) Filed: Dec. 21, 2011

(51) Int. Cl. G06F 3/00; G06F 9/46

(52) U.S. Cl. 719/313; 719/318

(57) ABSTRACT

A web page may initiate communication with a browser toolbar. In one example, the web page contains an invisible iframe, and code that causes the iframe to load a specific Uniform Resource Locator (“URL”). When the iframe loads that URL, it generates an onload event. The toolbar may subscribe to the iframe's onload event, and may contain a handler for that event. When the page wants to send a message to the toolbar, the page adds the message to a URL and then executes the code that causes the iframe to load that URL, thereby generating an onload event. The handler in the toolbar receives the onload event, and extracts the message from the URL. The handler may then execute additional code to perform an action in response to the message.

### BACKGROUND

Many web browsers support toolbars, which either extend the functionality of the browser or simplify the use of functions in the browser. For example, the operator of a set of web services may provide a toolbar that helps the user to use the web services. Such a toolbar might contain a search box to perform searches, a translation button to translate between languages, and an e-mail notifier to notify the user of incoming messages on the e-mail service that the operator provides.

Toolbars typically communicate with web pages by interrogating or examining the web page. For example, a translation function on a toolbar might learn what language a page is written in by examining the page or the page's metadata or URL. A map function might determine whether there are addresses on a page that can be mapped by examining the page and looking for text that appears to have the syntax of an address. This technique of communication between a web page and a toolbar works for pages that are passive, or that are unaware of the existence of the toolbar. However, there are certain circumstances in which toolbar-initiated examination of a web page make implementation of certain functions difficult or impractical.

### SUMMARY

Communication with a toolbar may be initiated by a page in a browser. A web page may have a hidden iframe element. The toolbar may subscribe to the onload event (or other type of event) for the iframe. When code on the page (e.g., an ECMA-262 script, or “JavaScript”) wants to communicate with the browser, it may cause the iframe to navigate to some Uniform Resource Locator (“URL”). Since the toolbar is subscribed to the onload event for the iframe, causing the iframe to load a page consequently causes the toolbar's onload handler to be invoked. That handler has access to the URL that caused the onload event, so a message to be communicated to the browser can be included in the URL—e.g., as a parameter appended to the end of the URL. In this way, a page can communicate information to the toolbar, and the toolbar may take action based on the information that it receives from the page.

Using a similar technique, the toolbar can also communicate with a web page. For example, the web page can subscribe to the iframe's onload event. When the toolbar wants to send a message to the web page, the toolbar can cause the iframe to load a URL. Since the web page is subscribed to the iframe's onload event, when the toolbar causes the iframe to load a URL, this action invokes the web page's onload handler. The toolbar may incorporate a message into the URL, thereby communicating this message to code on the web page when the web page's onload handler receives the URL.

Various types of toolbar actions could be implemented with page-initiated communication. For example, a web-based game could send notifications to the toolbar for the toolbar to communicate to a user, or could instruct the toolbar to show visual rewards (e.g., gold stars, diamonds, etc.) when a user reaches certain score milestones. As another example, a shopping and/or payment web site could maintain a monetary balance for the user, and could communicate this balance to the toolbar, so that the toolbar can display the user's balance. As yet another example, a web site could query a toolbar to find out what toolbar applications are installed, and the web site could either offer, or not offer, the user the chance to install those applications depending on whether they are already installed. The foregoing are merely some examples of actions that could be performed using page-initiated communication to a toolbar, and the subject matter herein is not limited to these examples.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example browser in which communication between a browser and a toolbar may occur using the techniques described herein.

FIG. 2 is a flow diagram of an example system in which a toolbar communicates with a web page.

FIG. 3 is a flow diagram of an example process in which a web page may communicate with a browser toolbar.

FIG. 4 is a block diagram of example components that may be used in connection with implementations of the subject matter described herein.

### DETAILED DESCRIPTION

Many browsers support toolbars, which either extend the functionality of a browser, or make certain functions easier to access. Early toolbars were provided by search engine operators. Such toolbars directed traffic to the operator's search engine by making it easier for users to perform searches on that operator's web site—e.g., the Google toolbar provided a search box that would forward, to the Google search engine, a query that the user entered into the toolbar's search box. As web applications and web pages became more sophisticated, toolbars increased in functionality. For example, a toolbar can scan a web page to detect the presence of mailing addresses, so that the toolbar can offer to display a map of that address. Or, a toolbar can detect the presence of text in a language other than the user's main language, and can offer to have the text of the web page translated into the user's language. Other toolbar functions may include providing incoming mail notification, providing current weather reports, providing news stories, and various other functions.

The functions performed by toolbars typically fall into two categories. In one category, the toolbar loads information from the web independently of what pages have been loaded into the windows or tabs of the browser. For example, a weather function on a toolbar may know the address of a weather service's web Application Programming Interface (“API”), and may “hit” the URL of the web API to receive the current weather. The toolbar may then display this weather to the user. Functions in this category might obtain and display information from the web without communicating with the content that has been loaded into the browser's windows or tabs.

A second category of functions performed by toolbar include those functions in which the toolbar examines the content of a web page that has been loaded into a window or tab, and then performs some function based on the content of the page. For example, the translation button on a toolbar might work by examining a page's metadata (which may indicate the language of the page), or by sending a sample of the text on the page to a translation web site for language recognition analysis. In the second category of functions, the toolbar initiates contact with the page in order to perform a function.

The subject matter described herein provides a mechanism that allows a web page to initiate contact with a toolbar in real time. There is no standard way of allowing web pages to communicate with toolbars, so the techniques described herein effectively provide a type of API to allow this type of communication. In order to allow a web page to initiate contact with a toolbar, the web page may include a hidden iframe. An iframe, is a construct of Hypertext Markup Language (“HTML”). The iframe might be hidden in the sense that it does not contribute to the visual content that the browser displays. However, an iframe can load a URL, and can also generate events. When an HTML iframe loads a URL, the iframe generates an onload event. In order for a toolbar to receive messages from the page, the toolbar subscribes to the iframe's onload event. The onload event that is generated when the iframe loads a URL triggers the toolbar's onload handler, and also provides the handler with the URL that was loaded. Thus, a script running on the web page (e.g., an ECMA-262 script, or “JavaScript”) can communicate a message to the toolbar by creating a URL with an appended message, and causing the iframe to load that URL. When the toolbar's onload handler is invoked, it retrieves the message from the URL, and may take action based on the message. (The description of the subject matter herein refers to the iframe's “onload” event. However, the same technique can work with any event that has the properties that (a) it can be triggered by a page, and (b) it can be subscribed to by a toolbar running in the web browser. Preferably, but optionally, the event would also have the property that it can pass data, although this property is not needed since the data to be communicated can be put elsewhere in an agreed upon location. It will be understood that references in the description to the “onload” event are merely examples, and that the techniques described herein can be implemented with other types of events.)

Using a similar process, a toolbar can send a message to code on the web page. The web page can subscribe to its own iframe's onload event, such that the iframe's loading of a URL invokes the page's onload handler. In order for the toolbar to send a message to the web page, the toolbar creates a URL with a message, and causes the page's iframe to load that URL. Loading of the URL invokes the page's onload handler, which can then retrieve the message from the URL.

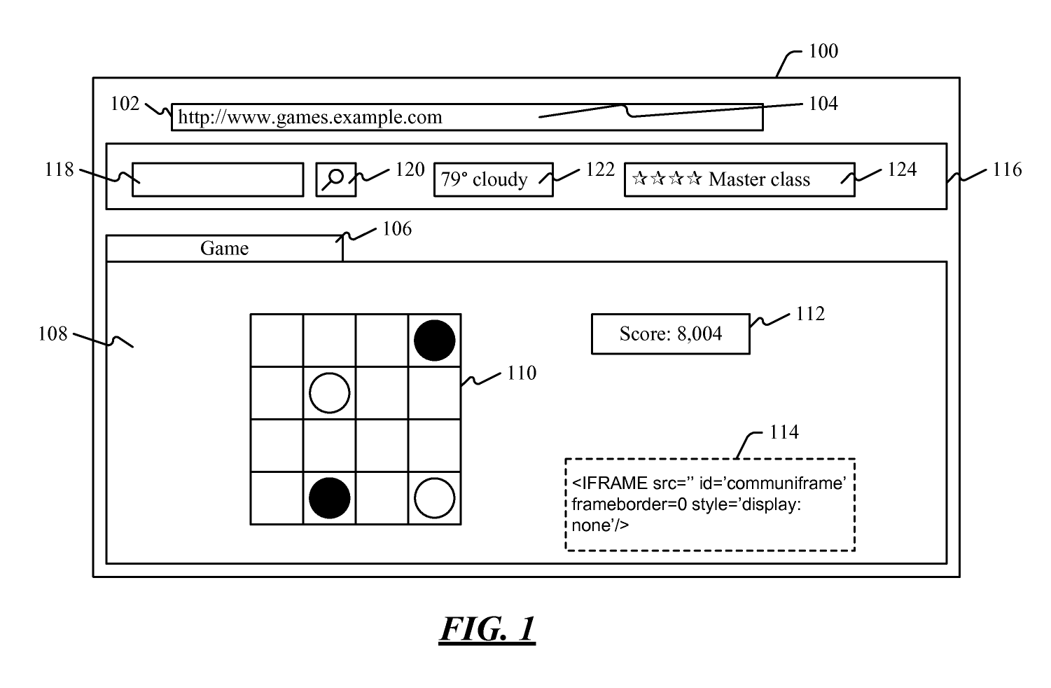

Turning now to the drawings, FIG. 1 shows an example browser in which communication between a browser and a toolbar may occur using the techniques described herein. Browser 100 is a browser software application, such as the INTERNET EXPLORER browser, the Firefox browser, the Chrome browser, or any other appropriate browser program. Browser 100 provides a navigation bar 102, which allows a user to specify a URL 104 which the browser is to load. The URL 104 may be loaded in a tab 106, if the browser provides tabs, or may be loaded as the sole page in the browser's window if the browser does not provide tabs.

The URL 104 points to a page 108, which contains some type of content. In the example shown in FIG. 1, the content is a board game, although any type of content could be used. The visual content shown in the example of FIG. 1 includes a game board 110 and a score 112. In addition to this visual content, page 108 may also contain an iframe 114. In FIG. 1, iframe is shown within dotted lines, in order to indicate that—in a real browser—the content of iframe might not be visible. However, in order to aid discussion of the subject matter herein, the content of iframe is shown in FIG. 1, even though such content might not be visible in an actual implementation.

Iframe 114 contains sufficient HTML code to define and name the iframe, so that it can be addressed by code on page 108, and also by toolbar 116. In particular, iframe 114 contains the code “<IFRAME src=” id=‘communiframe’ frameborder=0 style=‘display: none’/>”. This code defines a frame with the addressable name “communiframe”, which does not display within a browser window or tab.

Toolbar 116 is a toolbar that may be built into browser 100, or that may be installed as an extension to browser 100. Toolbar 116 provides various functions, such as search box 118 and search button 120, weather report 122, and score report 124. With regard to the content on page 108, score report 124 is able to interact with that content. In particular, score report 124 displays some number of stars and a verbal rating, depending on how well the player of the game on page 108 is performing. In the example shown, page 108 may report to toolbar 116 that the player has a score of 8,004, thereby causing score report 124 to show four stars and the verbal designation “master class.” Techniques described below may be used to allow code on page 108 to inform toolbar 116 of the player's score, so that the toolbar can take the action of displaying the graphical and verbal indications of the player's rating.

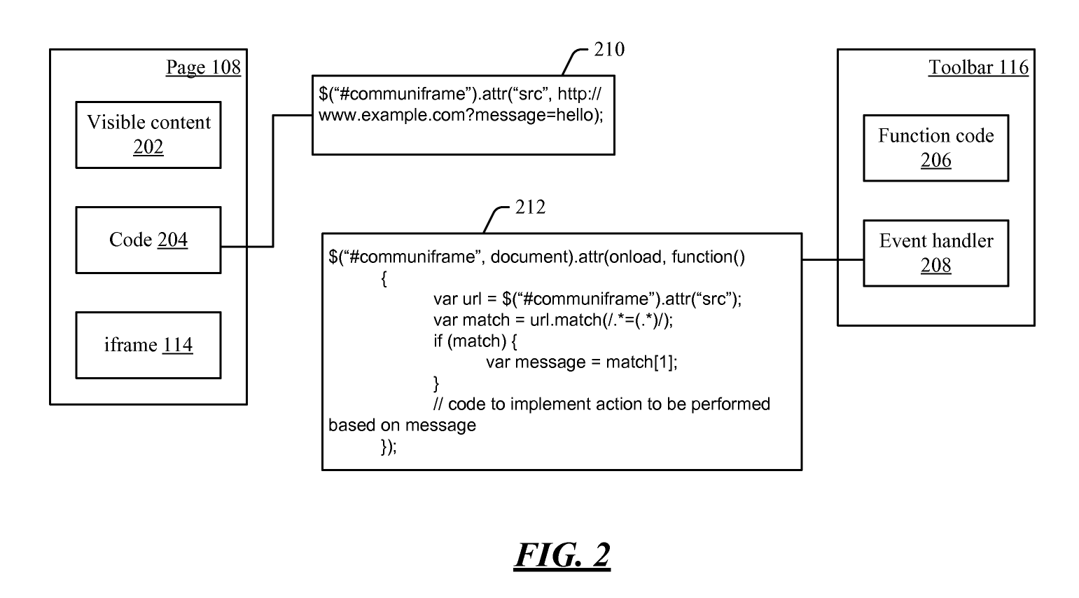

FIG. 2 shows an example system in which a toolbar communicates with a web page. Page 108 may comprise visible content 202, code 204, and iframe 114. Visible content 202 may contain text, images, animations, multimedia, or any other kind of content. Code 204 may be one or more script that can be executed by a browser, such as ECMA-262 scripts, or “JavaScripts”. Iframe 114 may be a non-visible part of page 108, which may contain code such as that shown in FIG. 1 and discussed above.

Toolbar 116 may contain function code 206 and event handler 208. Function code 206 may contain the code that implements one or more functions of the toolbar. For example, function code may implement a search box, a weather report feature, and the score report feature described above in connection with FIG. 1. Event handler 208 may contain code that responds to an onload event generated by page 108.

As noted above, code 204 may include scripts that can be executed by a browser. As also noted above, one of the things that page 108 may want to do is to communicate a message to toolbar 116. Page 108 can communicate such a message through the use of appropriate code. An example of code to communicate a message is shown in block 210, which may be part of the code 204 that is in page 108. As can be seen, the code in block 210 is:

$(“#communiframe”).attr(“src”, http://www.example.com?message=hello); This code changes the source of the iframe to the URL “http://www.example.com?message=hello”, thereby causing that URL to be loaded into the iframe. (The iframe's addressable name is “communiframe”, which is why the above code addresses the iframe by that name.) In effect, what this code does is to send the message “hello” to the toolbar (as well as to any other entity that is subscribed to the iframe's onload event). Page 108 can execute this line of script when it wants to send a message to toolbar 116. (The actual content pointed to by the URL may be irrelevant to the message that is being communicated. For example, www.example.com might be a “dummy” URL that points to a blank page. The purpose of causing the iframe to load the URL is mainly to trigger the onload event, thereby communicating information to the toolbar.)

When the source of the iframe is changed by the above code, the result is to generate an onload event in iframe 114. Event handler 208 subscribes to this event by containing code that responds to the event. In the example shown FIG. 1, event handler 208 contains the code shown in block 212, which is:

$(“#communiframe”, document).attr(onload, function( )
{

var url = $(“#communiframe”).attr(“src”);
var match = url.match(/.*=(.*)/);
if (match) {

var message = match[1];

}
// code to implement action to be performed based on message

});

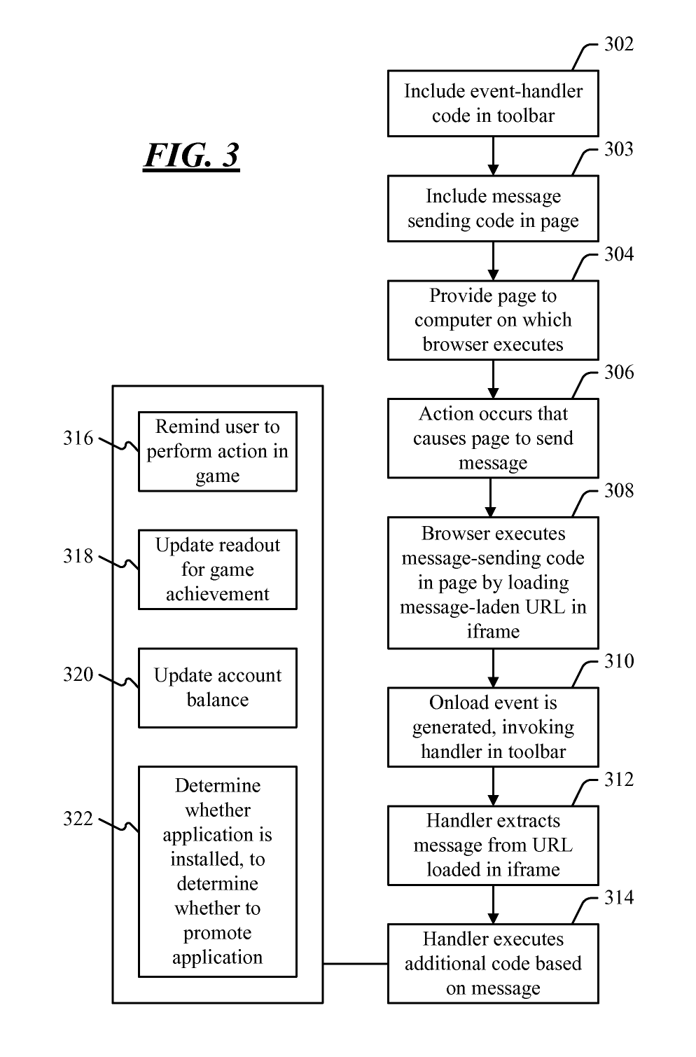

What this code does is the following: The phrase “$(”communiframe“, document)” refers to the iframe in the current document (where “commniframe” is the addressable name of the iframe). “attr” is an attribute of the iframe, whose arguments are an event, and a function. Invoking the attr object on the communiframe with the arguments “(event,function)” means that when the iframe generates “event”, “function” is to be executed. In this case, the “event” is “onload”, and the function is an anonymous function that is defined inline (although, in another example, the function could be defined elsewhere and referred to by a symbolic name rather than being defined inline). The anonymous inline function in this example assigns the variable named “url” to be the URL that has been loaded by the iframe (which is stored in the attribute labeled “src”). It then uses the “match” method to extract the portion of the url string that occurs after the first equal sign, and to put that extracted portion into the string array named “match”. In this case, the portion that follows the equal sign is “hello”. The variable name “message” is then assigned to be equal to the first string in the “match” string array. In this example, the variable “message” will contain the string “hello”. Code that responds to “message” is then included in the function. (This code would be included in the place marked by the comment symbol “//”.)The actual code that would be included depends on what the toolbar wants to do when it receives a message. For example, the code might contain a switch that performs various different actions depending on what string is contained in the “message” variable. Moreover, some specific example actions that the code could be performed are described below in connection with FIG. 3. Toolbar 116 executes the code to perform the action.

It is noted that a message could be transmitted in the reverse direction—i.e., from toolbar 116 to page 108—using a technique similar to that described above, simply by using the event handling code in block 212 (or similar code) as part of page 108, and the message-sending code in block 210 (or similar code) as part of toolbar 116.

FIG. 3 shows an example process in which a web page may communicate with a browser toolbar. Before turning to a description of FIG. 3, it is noted that the flow diagram contained in FIG. 3 is described, by way of example, with reference to components shown in FIGS. 1 and 2, although this process may be carried out in any system and is not limited to the scenarios shown in FIGS. 1 and 2. Additionally, the flow diagrams in FIG. 3 shows an example in which stages of a process are carried out in a particular order, as indicated by the lines connecting the blocks, but the various stages shown in this diagram can be performed in any order, or in any combination or sub-combination.

At 302, event handling code may be included in a toolbar, where the handler is invoked in response to an “onload” event. At 303, message sending code is included in a page. For example, the code shown in FIG. 2 that causes a particular URL to be loaded into an invisible iframe may be included in a page. At 304, the page may be provided to a computer on which a browser executes, so that the page may be loaded into the browser. Thus, when the message-sending code in the page is invoked, it generates an onload event, which causes the event-handling code in the toolbar to be invoked.

At 306, an action occurs in the page that causes the page to send a message. Any type of action may cause a message to be sent. Some example actions are described below at 316-322. A URL may be created that carries the message to be sent. The code that was included at 302 executes at 308, thereby causing the message-laden URL to be loaded into the iframe.

At 310, the loading of the URL into the iframe causes the iframe to generate an onload event, which invokes the handler in the toolbar. At 312, the handle extracts the message from the URL. At 314, the handler may then execute additional code to perform a further action. In one example, the further action that is performed is based on the message, so that different messages cause different actions to be performed. However, in another example, the mere loading of the URL into the iframe conveys the message, in which case either the URL does not contain a message string, or—if it does contain a message string—the message string may be ignored by the handler. (It is also noted that if the user's browser has no toolbar—or no toolbar that is equipped to receive communications in the way described herein—then the actions performed by the iframe would have no adverse effect.)

A toolbar could be used to perform any action in response to a message from a page. However, at 316-322, various example actions and scenarios are shown.

One example scenario (at 316) is that the page contains a game, and the message that the page sends to the toolbar instructs the toolbar to display a reminder the user to perform some action in the game at a future time when the user might or might not be at the same page. For example, the game might be a farming-oriented role-playing game, and the page that implements the game might want to remind the user periodically to water his or her virtual crops in the game. In this case, the page could use the techniques described above to send a “water_crops after x hours” message to the toolbar. The toolbar may respond to this message by executing code that causes a message such as “Water your crops” to be displayed on the toolbar after a specified time. In this example, the toolbar will take an action based on a timer expiration.

Another example scenario (at 318) is updating a readout showing a player's achievement in a game. For example, if the page implements a game and includes code to maintain the player's score, the toolbar might want to show an achievement level in some way, so that the player can see how well he or she is doing even if the tab in which the game is being played is hidden or the player has navigated away from the page. (FIG. 1 shows an example of such an achievement indication: four stars and the words “master class” indicate the user's level of achievement in the game that is shown in FIG. 1.) In this case, when the player's score changes on the page, the change in score may be an action that causes message-sending code to be invoked. The page may then create a URL that described the achievement level to be shown. For example, with reference to the example of FIG. 1, the message might be “four_stars_master_class”, which could be included in the URL “http://www.example.com/q=four_stars_master_class”. The event handler may contain code that can decode this message, and that can display the appropriate achievement level on the toolbar.

Yet another example scenario (at 320) is updating an account balance. For example, the page may be the dashboard of a shopping site and/or payment service, and the user may have a certain amount of credit on account (e.g., the currency balance for a micropayment account, or the rewards point balance for a rewards account). The toolbar may show the current balance as well, so the user can see the balance even if the tab containing the dashboard is hidden. When the user makes a payment, the balance shown on the dashboard may update, which may cause the dashboard to notify the toolbar to update its display of the balance as well. Thus, the page may compose a message containing the new balance, and the message-sending code in the page may cause this message to be sent to the toolbar. The toolbar can then update its record of the balance, and can therefore show the user his or her current balance on the toolbar.

Yet another example scenario (at 322) is where a toolbar can determine whether a particular application is installed (either in the toolbar itself, or elsewhere on the user's machine), and the page wants to know whether that application is installed. For example, the page may try to encourage installation of an application by showing users a promotion for the application. However, the page might not want to promote the application to users who have already installed the application. Therefore, the page may contain code that conditionally chooses whether to show the message “Download the X application now.” The code decides whether to print this message depending on whether the X application is already installed on the user's machine. Thus, the page sends the toolbar a message requesting to find out whether the application is installed. The action that the toolbar can take is to determine whether the application is installed, and then to send a message back to the page indicating whether the application is installed. The page can then either display the message, or not, depending on the response it receives. As discussed above, the same techniques that are used to allow page-to-toolbar communication can be used to allow toolbar-to-page communication, thereby allowing the toolbar to reply to the page's inquiry. (In addition to the techniques described herein, any other techniques that allow toolbar-to-page communication could be used by the toolbar to reply to the page's inquiry.)

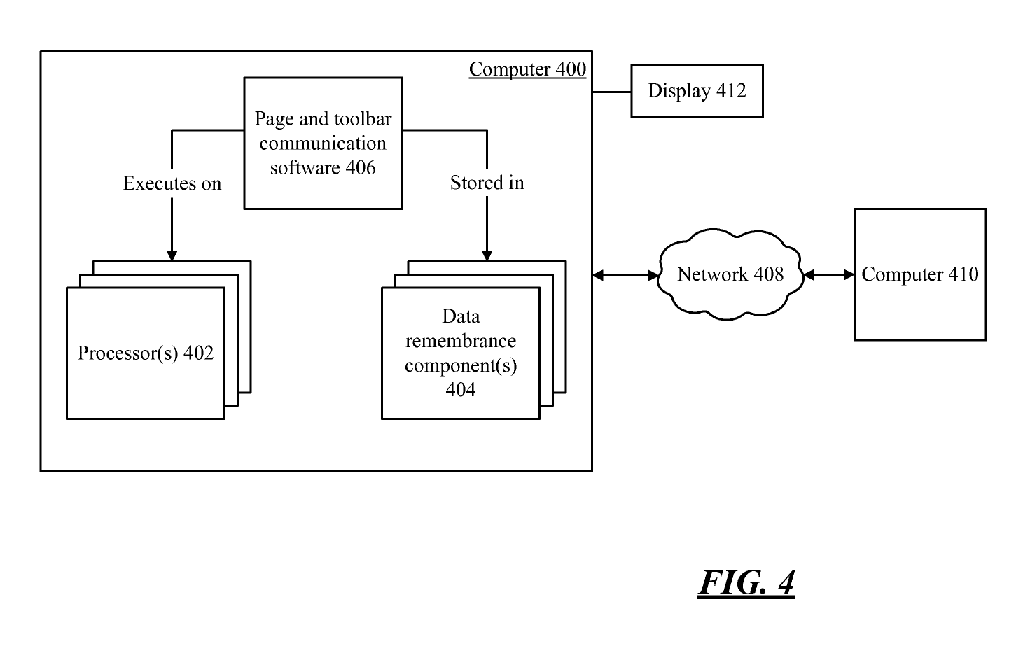

FIG. 4 shows an example environment in which aspects of the subject matter described herein may be deployed.

Computer 400 includes one or more processors 402 and one or more data remembrance components 404. Processor(s) 402 are typically microprocessors, such as those found in a personal desktop or laptop computer, a server, a handheld computer, or another kind of computing device. Data remembrance component(s) 404 are components that are capable of storing data for either the short or long term. Examples of data remembrance component(s) 404 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 400 may comprise, or be associated with, display 412, which may be a cathode ray tube (CRT) monitor, a liquid crystal display (LCD) monitor, or any other type of monitor.

Software may be stored in the data remembrance component(s) 404, and may execute on the one or more processor(s) 402. An example of such software is page and toolbar communication software 406, which may implement some or all of the functionality described above in connection with FIGS. 1-3, although any type of software could be used. Software 406 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 4, although the subject matter described herein is not limited to this example.

The subject matter described herein can be implemented as software that is stored in one or more of the data remembrance component(s) 404 and that executes on one or more of the processor(s) 402. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 402) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 400 may be communicatively connected to one or more other devices through network 408. Computer 410, which may be similar in structure to computer 400, is an example of a device that can be connected to computer 400, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium comprising executable instructions to communicate between a web page and a browser toolbar, the executable instructions, when executed by a computer, causing the computer to perform acts comprising:
subscribing to an event in an iframe of a web page loaded into a browser, said executable instructions being part of a toolbar in said browser;
receiving an event indicating that a Uniform Resource Locator (URL) has been loaded in said web page;
in response to said event, executing a handler in said toolbar; and
performing an action based on said event.

2. The computer-readable medium of claim 1, said iframe being an invisible iframe that said browser does not display, said URL being loaded in said web page by being loaded into said iframe.

3. The computer-readable medium of claim 1, said URL comprising a message that said web page sends to said toolbar, said action being performed further based on a said message.

4. The computer-readable medium of claim 1, said web page providing a game, said web page including a message in said URL and sending said message to said toolbar, said message instructing said toolbar set a timer and to display a reminder to a player of said game to perform an action in said game in response to expiration of said timer.

5. The computer-readable medium of claim 1, said web page providing a game, said web page maintaining a score of a player on said web page, said web page including a message in said URL and sending said message to said toolbar in response to a change in said score, said message comprising said score, said toolbar changing a visual indication of achievement in response to receiving of said message.

6. The computer-readable medium of claim 1, said web page providing a dashboard of a payment service, said web page maintaining an account balance of a user of said payment service, said web page including a message in said URL and sending said message to said toolbar in response to a change in said balance, said message comprising said balance after said change, said toolbar changing a visual indication of said balance in response to receiving of said message.

7. The computer-readable medium of claim 1, said web page containing code that conditionally shows a promotion for an application, said web page communicating with said toolbar to determine whether said application is installed on a computer on which said browser executes, said toolbar responding with an indication of whether said application is installed, said web page choosing whether to show, or not to show, said promotion based on said indication.

8. A method of communicating between a web page and a toolbar, the method comprising:
using a processor to perform acts comprising:
providing, to a computer on which a browser executes, a web page to be displayed in said browser, said toolbar being installed in said browser, said web page comprising an iframe, said toolbar being subscribed to an event of said iframe, said web page comprising first code to perform acts comprising:
creating a Uniform Resource Locator (URL);
causing said iframe to load said URL; and
generating said event when said iframe loads said URL, said event being received by a handler in said toolbar, said handler causing second code to execute when said event is received.

9. The method of claim 8, said iframe being an invisible iframe that said browser does not display.

10. The method of claim 8, said URL comprising a message that said web page sends to said toolbar, said second code performing an action that is based on said message.

11. The method of claim 8, said web page providing a game, said web page including a message in said URL and sending said message to said toolbar, said message instructing said toolbar to set a timer, said second code, in response to said message, setting said timer and displaying a reminder to a player of said game to perform an action in said game in response to expiration of said timer.

12. The method of claim 8, said web page providing a game, said web page maintaining a score of a player on said web page, said web page including a message in said URL and sending said message to said toolbar in response to a change in said score, said message comprising said score, said second code, in response to said message, changing a visual indication of achievement on said toolbar.

13. The method of claim 8, said web page providing a dashboard of a payment service, said web page maintaining an account balance or rewards point balance of a user of said payment service, said web page including a message in said URL and sending said message to said toolbar in response to a change in said balance, said message comprising said balance after said change, said second code, in response to said message, changing a visual indication of said balance on said toolbar.

14. The method of claim 8, said web page containing code that conditionally shows a promotion for an application, said page communicating with said toolbar to determine whether said application is installed on a computer on which said browser executes by causing said iframe to load said URL, said second code responding to communication from said web page with an indication of whether said application is installed, said web page choosing whether to show, or not to show, said promotion based on said indication.

15. A system for communicating between a web page and a browser toolbar, the system comprising:
a memory;
a processor;
a web page that is stored in said memory and that is loaded into a browser, said web page comprising an iframe, said web page further comprising first code that causes said iframe to load a Uniform Resource Locator (URL), said iframe generating an onload event when said URL is loaded into said iframe; and
a toolbar component that is stored in said memory and that executes on said processor, said toolbar component being installed in said browser, said toolbar component subscribing to said onload event of said iframe and causing second code in said toolbar to execute in response to said onload event, said second code performing an action.

16. The system of claim 15, said iframe being an invisible iframe that said browser does not display.

17. The system of claim 15, said URL comprising a message that said web page sends to said toolbar, said second code performing said action based on said message.

18. The system of claim 15, said web page providing a game, said web page including a message in said URL and sending said message to said toolbar, said message instructing said second code to set a timer and to display, on said toolbar, a reminder to a player of said game to perform an action in said game in response to expiration of said timer.

19. The system of claim 15, said web page providing a game, said web page maintaining a score of a player on said web page, said web page including a message in said URL and sending said message to said toolbar in response to a change in said score, said message comprising said score, said second code changing a visual indication of achievement on said toolbar in response to receiving of said message.

20. The system of claim 15, said web page providing a dashboard of a payment service, said web page maintaining an account balance or rewards point balance of a user of said payment service, said web page including a message in said URL and sending said message to said toolbar in response to a change in said account balance or said rewards point balance, said message comprising said account balance or said rewards point balance after said change, said second code changing a visual indication of said account balance or said rewards point balance on said toolbar in response to receiving of said message.
